(19) United States
(12) Patent Application Publication
(10) Pub. No.: US 2011/0037560 A1
(43) Pub. Date: Feb. 17, 2011

(54) METHOD FOR INDIVIDUAL GUIDANCE AND ASSOCIATED DEVICE

(76) Inventor: Jacques Belloteau, Issy Les Moulineaus (FR)

Correspondence Address: YOUNG & THOMPSON, 209 Madison Street, Suite 500, Alexandria, VA, 22314, US

(21) Appl. No.: 12/937,809

(22) PCT Filed: Apr. 14, 2009
(86) PCT No.: PCT/FR09/00424

§ 371 Date: Oct. 14, 2010

(30) Foreign Application Priority Data
Apr. 14, 2008 (FR) 0852497

(51) Int. Cl. G09B 21/00

(52) U.S. Cl. 340/4.1

(57) ABSTRACT

A guiding device includes: a fixed guiding device consisting of a marking (130, 211,311) containing an electroconductive material, on a pre-defined path that can be used by a visually impaired person, parallel to the path, characterised in that the quantity and/or distribution of the conductive material is uniform over the marking parallel to the path over a distance of at least one metre and is variable close to events on the path; and a mobile guiding device to be used together with the fixed guiding device and characterised in that it includes a stick (201, 301), a sensor (202, 302) consisting of an electroconductive material positioned at the distal end of the stick, and an element (203 to 210, 303 to 305) for warning the user whenever the sensor detects an event.

The present invention concerns a method of guiding persons and an associated device. It is applied, in particular, to guiding persons having a visual handicap, the poorly sighted and the blind using sound and/or tactile signals.

Guidance means known at present for assisting the poorly sighted essentially include:
the rigid white cane for detecting an obstacle at a distance by touching it with the end of the cane,
trained dogs that recognize obstacles and guide their master or mistress, and
paving slabs carrying a raised pattern for indicating the edge of a roadway or a platform.

Such means are very limited and do not provide real guidance for their users.

Other known systems, notably those described in the documents XP-002511006, JP 09 297891, ES 2 156 518, DE 36 16 186, SU 1 454 458, FR 2 382 886, JP 09 328 725, DE 37 11 469, JP 60 134 308, US 2006/0289624, WO 97/33548, US 2003/037720 and FR 2 628 968 provide metal or magnetized strips. However, these systems are not able to warn the user of an approaching hazard (edge of sidewalk or platform, stairs, for example) or necessitate learning new movements for stopping and sweeping a small area in which information elements are located.

The present invention aims to remedy these drawbacks and notably to enable the unsighted to move autonomously, with the same movements that they are used to effecting using a cane, in a predefined place, on a marked out path, and using an orientation system. Thus users do not have to change the movements that they are used to effecting in order to follow a path or to be warned of an approaching obstacle on the path.

To this end, a first aspect of the present invention provides a fixed guidance device that includes, on a predefined path that a poorly sighted person may take, parallel to that path, a line containing an electrically conductive material, characterized in that the quantity and/or the distribution of said conductive material is uniform parallel to said path over a distance of at least one meter and variable near events located on said path.

Accordingly, because the quantity or the distribution of the conductive material is uniform over at least one meter, during the oscillatory movement that the poorly sighted person traditionally imparts to their cane, the cane crosses said uniform quantity and/or distribution at least once and the person can therefore become aware of impending events on their path without slowing their pace.

According to particular features, said line consists of a metal wire at least five centimeters below the surface of the ground.

According to particular features, said line has, over distances of at least one meter, an increased width to indicate an impending first predetermined event on said path.

According to particular features, said line has, over distances of at least one meter, at least two parallel electrically conductive elements to indicate the impending of a first predetermined event on said path.

A second aspect of the present invention provides a mobile guidance device for use conjointly with the fixed guidance device of the present invention, characterized in that it includes:
a cane,
an electrically conductive material detector positioned at the distal end of the cane, and
means for advising the user each time said detector detects an electrically conductive material.

According to particular features, the device of the present invention, as succinctly described hereinabove, further includes means for interpreting a quantity and/or distribution of electrically conductive material, the means for warning the user being adapted to transmit a message representing the interpretation provided by the interpretation means.

Thanks to these arrangements, messages may be coded for the attention of users, for example to inform them of the presence of a step, a staircase, roadworks or the available directions at a branching of a plurality of conductive lines or their location.

According to preferred features, the device of the present invention, as succinctly described hereinabove, includes geolocation means adapted to identify the geographical position of the device and to provide information linked to that position, the means for warning the user being adapted to transmit a message representing the information provided by the geolocation means.

Thanks to these features, rich and easily updated information may be made available to the user.

According to particular features, the sensitivity of the electrically conductive material detector is adapted not to detect the line except at a distance less than ten centimeters.

This prevents interference with metals deep underground, for example metal pipes.

According to particular features, the means for warning the user include:
a wireless signal transmitter receiving the signals transmitted by the material detector, and
a receiver of said signals transmitted by said transmitter associated with a sound signal emitter that emits a sound signal near at least one ear of the user.

Thanks to these features, the presence of a wire is avoided and the device is discreet to use.

The advantages of this mobile guidance device being similar to those of the fixed guidance device of the present invention with which it may cooperate, as succinctly disclosed hereinabove, those advantages are not repeated here.

A third aspect of the present invention provides a guidance method characterized in that it includes a step of marking at least one path that may be taken by a visually impaired person to place thereon a line including an electrically conductive material, the quantity and/or the distribution of said conductive material being uniform parallel to said path over a distance of at least one meter and variable near events on said path.

The advantages, objects and features of this method being similar to those of the fixed guidance device of the present invention as succinctly disclosed hereinabove, those advantages are not repeated here.

Other particular advantages, objects and features of the present invention will emerge from the following explanatory and nonlimiting description with reference to the appendices, in which:

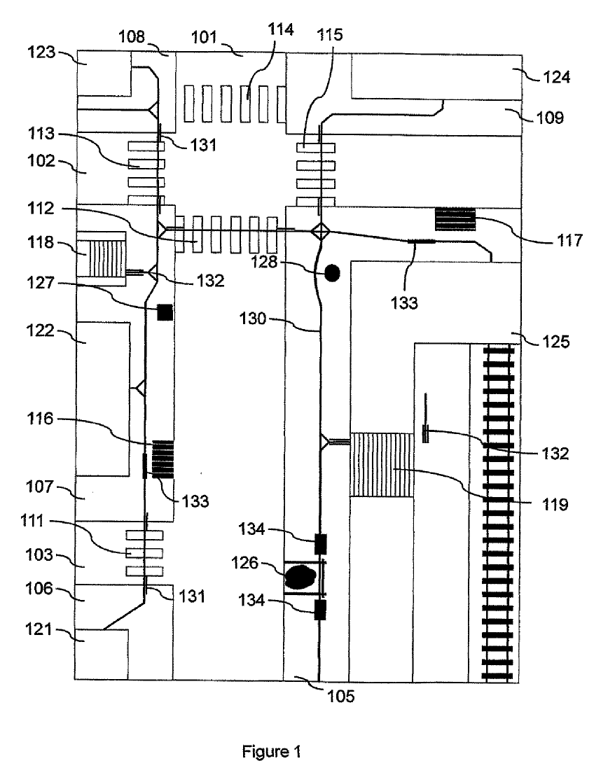

FIG. 1 represents diagrammatically in plan view the fixed guidance device of one particular embodiment of the present invention,

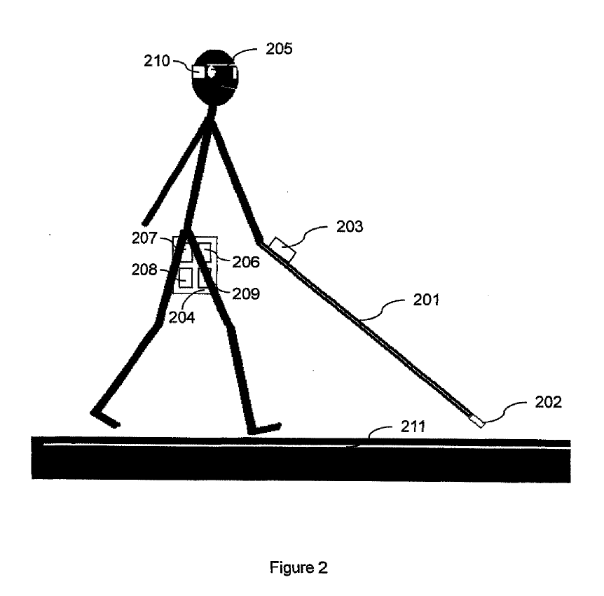

FIG. 2 represents diagrammatically in elevation the mobile guidance device of a first particular embodiment of the present invention,

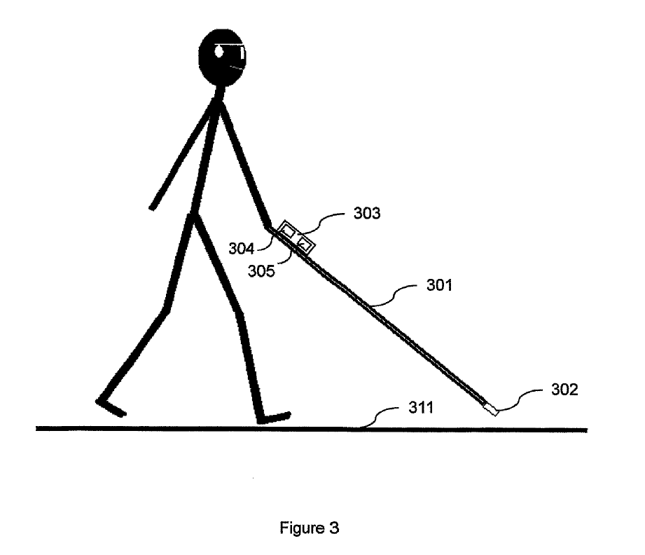

FIG. 3 represents diagrammatically in elevation the mobile guidance device of a second particular embodiment of the present invention, and

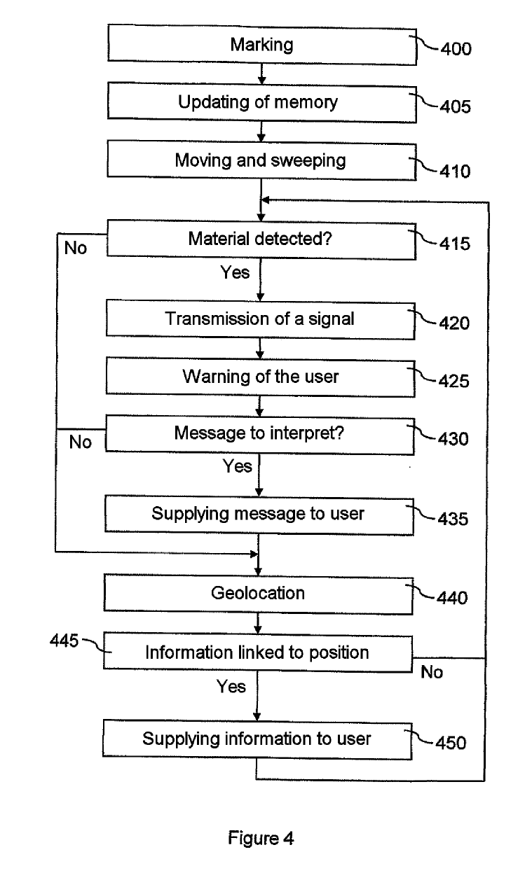

FIG. 4 represents in flowchart form the steps of the guidance method of one particular embodiment of the present invention.

Throughout the description there is described an application of the present invention using modulation of electrical conduction by a line and detection of electrical conduction variation.

FIG. 1 shows, on a street map, three automobile traffic carriageways 101 to 103, five sidewalks 105 to 109 flanking these carriageways, protected crossings 111 to 115 connecting these sidewalks via the carriageways, bus stops 116 and 117 on these sidewalks, an underground railway entrance 118, a train station entrance 119, public buildings or places 121 to 125, an area 126 in which roadworks are being carried out, and two manhole covers 127 and 128.

The underground railway entrance 118 and the train station entrance 119 have stairways. The roadworks area 126 is a hole excavated in a sidewalk, surrounded by protective barriers of known type. The manhole covers 127 and 128 are access manhole covers to underground networks or pipes, for example.

Also seen on the FIG. 1 street map are places on the ground containing a conductive electric material, including single lines 130, double lines 131, triple lines 132, slightly widened lines 133 and greatly widened lines 134.

Note that the quantity and/or the distribution of the electrically conductive material is uniform parallel to the path followed by these lines over a distance of at least one meter, preferably at least two meters, and varies near events on said path.

The lines on the ground are preferably formed by installing in at least one shallow groove at least one metal wire the diameter and/or the number of which is constant over a length of at least one meter and varies near events on the path of the poorly sighted person to be reported.

There may be employed successively for this purpose:
a bitumen saw, as used in public works for access to underground pipes,
a grooved wheel paying out length of metal wire of at least one meter into each groove, and
a dispenser of caulking material, for example paste or adhesive.

The lines on the ground may also be formed by depositing a binder and the conductive material in a liquid or paste form, like a line painted on the carriageway. They may also be formed by bonding or melting tapes or by installing in a shallow groove a liquid, paste or malleable substance containing a conductive material that can be detected by a metal detector.

The lines 130 to 134 on the ground, for which the quantity and distribution of electrically conductive material are constant for each segment of at least one meter, preferably at least two meters, have different meanings:
the single lines 130 follow practically all of a path that may be taken by the user, and their width/diameter is one unit of width, for example five centimeters,
the double lines 131 have two parallel lines of unit width separated by a unit of width; they indicate an approaching sidewalk edge or a single step and extend perpendicularly to that edge over 1.5 meters on either side of that edge, for example,
the triple lines 132 have three parallel lines of unit width separated by a unit of width; they indicate the approach of a stairway and extend perpendicularly to each end step of that stairway over 1.5 meters from that end step, for example,
the slightly widened lines 133 have a triple width, for example, or a double diameter in the case of wires, compared to that of the single line; they indicate the presence of a bus stop, and
the greatly widened lines 134 have, for example, a width at least six times greater, or a diameter at least four times greater in the case of wires, than that of the single line; they indicate the approach of a hazard in the immediate vicinity of the line, such as a hole or roadworks on the sidewalk.

Note that, to avoid startling the user, the lines do not include right-angles.

Note also that bifurcations are formed by a triangle at the corners of which the lines terminate, rather than a direct intersection of the lines, again in order not to startle the user. These triangles preferably have a side length of the order of one meter.

Note further that lines cross at squares rather than intersections of perpendicular straight lines, again with the aim of not startling the user. The straight lines representing the crossing paths cross the square along its diagonals.

Alternatively, instead of parallel lines the same width, parallel lines of different widths are used, combinations of which represent different meanings, like barcodes. In this case also it is the distribution and/or the quantity of electrically conductive material that embodies the meaning of the signal.

Where the greatly widened lines 134 are concerned, they may be removable and positioned on the line 130 when the hazard to be indicated first appears, for example on excavating a hole on or near the line. Metal plates or flexible conductive tapes may be used to form such greatly widened lines, where appropriate lightly bonded or nailed to the ground.

As seen in FIG. 2, in the first embodiment of the present invention the mobile guidance device includes a support 201, a metal detector 202 positioned at the distal end of the support 201, a portable unit 204 and earphones 205.

The support 201 takes the form of a white cane of a length known in the field of aids for the blind. The metal detector 202 is adapted to detect the conductive material constituting the line over a distance of only a few centimeters, preferably less than or equal to ten centimeters. The metal detector 202 is connected to a wireless signal transmitter 203 that receives the signal from the metal detector. This signal transmitter 203 is a radio signal transmitter, for example, in which case the transmitter 203 includes an antenna. The portable unit 204 is adapted to be carried on the belt or in a pocket of the user. It includes a receiver 206 of signals emitted by the transmitter 203, a geolocation device 207, a geolocation data memory 208, and a radio signal transmitter 209.

The earphones 205 are adapted to be worn near at least one ear of the user and are connected to a radio receiver 210 adapted to receive signals transmitted by the radio transmitter 209.

The geolocation data memory is preferably adapted to be updated, for example by connection to a computer with Internet access or a removable information medium reader, for example a CD-ROM (Compact Disc Read Only Memory) reader. This updating may include data on roadworks being carried out on the paths followed by the lines of conductive material.

An electrically conductive material line 211 follows a path on which the user is located. As explained with reference to FIG. 1, the line 211 preferably includes an electrically conductive material the quantity and/or distribution of which indicates the proximity of an event, for example a hazard, on the path of the user. To this end, the quantity and distribution of the electrically conductive material are constant over lengths greater than one meter and preferably greater than two meters. The line 211 preferably consists of one, two or three metal wires parallel to the path. Alternatively, and for existing buildings in particular, the line consists of non-conductive paving slabs incorporating wires laid on the ground.

Obviously, when the user sweeps the surface in front of them with the distal end of the support, with an oscillatory movement well known to the blind, they pass the metal detector 202 over the line 211 on each oscillation, generally with a half-period less than two meters and even one meter. As soon as the metal detector 202 detects the line 211, and for as long it continues to detect it, it transmits a signal that is retransmitted by the transmitter 203 to the receiver 206 and then from the transmitter 209 to the receiver 210. The earpieces 205 then emit an audible sound the duration of which is substantially proportional to the quantity of conductive material with an evolution that represents the lateral distribution of the conductive material.

Through the durations and the alternations of the sound signals, the user therefore perceives not only the position of each element of the line 211 but also its characteristics, i.e. whether it is a single, double or triple, slightly widened or greatly widened line. The user can therefore follow the path and become aware of events or particular features, for example sidewalk edges, stairways, bus stops, hazards, bifurcations and crossings.

In the embodiment shown in FIG. 2, the unit 204 includes means for interpreting lines that interpret the duration of the signals transmitted by the metal detector and transmit a voice signal to the earpieces 205. Moreover, the geolocation device 207 of the unit 204 determines the position of the user in a manner known in the field of satellite positioning systems. Then, as a function of this position, it retrieves information in the geolocation database 208 on the user's location, the unit 204 then sending a voice signal representing that information. For example, on reaching them, the user is automatically given the names of streets, government buildings, bus stops, underground railway stations and train stations. Similarly, when the user reaches a bifurcation or crossing of conductive lines, the unit 204 seeks characteristic elements of the various directions available and, for example, indicates the name of the streets and the buildings for each direction taken by one of the conductive lines.

Alternatively, the content and the functions of the portable unit 204 are integrated into the support 201 and communication between the metal detector and the circuits of this unit integrated into the support is then by cable or wireless.

Alternatively, the signals transmitted by the metal detector are received directly by the receiver 210. In this way, the device shown in FIG. 2 is modular as the user may or may not opt to use the unit 204.

Alternatively, the metal detector is completed at the distal end of the support 201 by a reader of bar codes, visible or otherwise. For this function bar codes are placed on or near the conductive material line and provide information on the places, street names and directions as explained above with reference to geolocation information. In this case, the unit 204 includes bar code interpretation means and sends the receiver 210 a voice signal representing this interpretation.

Alternatively, there is provision for the use of metal bar codes read by the metal detector. This system may be used to give information or place names.

Thus the present invention enables blind persons to move autonomously, in a predefined place, over a marked out path using an orientation system employing sound.

As seen in FIG. 3, in the second embodiment of the present invention the mobile guidance device includes a support 301, a metal detector 302 positioned at the distal end of the support 301 and a handle 303 at the proximal end of the support 301.

The support 301 takes the form of a white cane with a length known in the field of aids for the blind. The metal detector 302 is connected by a cable or wireless connection to the handle 303. The handle includes an electro-acoustic transducer 304 and a vibrator 305. The electro-acoustic transducer 304 consists of an amplifier and a loudspeaker, for example. The vibrator 305 consists of a piezoelectric crystal, for example.

A conductive material line 311 similar to the line 211 runs along a path on which the user is located.

Obviously, when the user sweeps the surface in front of him with the distal end of the support with an oscillatory movement well known to blind persons, the metal detector 302 passes over the line 311 on each oscillation. As soon as the metal detector 302 detects the line 311, and for as long as it continues to detect it, it transmits a signal that is retransmitted in audible and tactile form by the electro-acoustic transducer 304 and/or the vibrator 305.

The duration of the audible sound and/or the vibration of the vibrator represents the quantity and distribution of the conductive material of the line 311, in a manner that is inversely proportional to the speed of angular movement of the support 301.

Thus through the durations and the alternations of the sound or tactile signals the user perceives not only the position of each element of the line 311 but also its characteristics, i.e. whether it is a single, double or triple line, slightly widened or greatly widened. They can therefore follow the path and be made aware of its particularities, sidewalk edge, stairways, bus stops, hazards, bifurcations and crossings.

In a particularly simplified embodiment of the device of the present invention, the device takes the form of a unit to be fixed to the end of a white cane, this unit including the line detector and a sound emitter. This unit emits a sound at a frequency and/or intensity that varies with the quantity of conductive material facing the distal unit and varying with the distance between this material and the unit.

As shown in FIG. 4, a first step 400 of one particular embodiment of the guidance method of the present invention marks at least one path that may be taken by a blind person to place there a line containing an electrically conductive material.

Techniques that may be used to produce the line include:
metal wire: at least one shallow groove is made in the ground all along the path to be produced; the number and width of the grooves are functions of the signaling to be effected and are constant over at least one meter, preferably at least two meters; the wire is disposed on the surface or at a depth of less than five centimeters so as to be more easily detected by the metal detector;
a liquid or paste substance incorporating a metal and that may be applied to the ground in the form of a thin line or in a groove; and
a synthetic material support that may be fixed to the ground, containing metal in any form.

As explained hereinabove, the line has a variable width to indicate the arrival of a predetermined event on the path and/or a variable number of parallel elements to indicate an impending predetermined event on the path.

Then, during a step 405, a geolocation data memory of the device of the present invention is updated, for example from a website via the Internet or from a CD-ROM. This updating may concern, for example, data on works being carried out on the paths followed by the lines formed during the step 400, activities open to the public in nearby buildings, bus or underground railway line numbers and their final destinations, timetables of these services.

Then, during a step 410, a user moves whilst sweeping the surface of the ground in front of them with the distal end of the device of the present invention.

During a step 415, whether the metal detector of the device is detecting the presence of the conductive material of the line is determined. If not, the next step is a step 440. If so, the metal detector transmits a signal representing this detection during a step 420. During a step 425 the user is advised of the detection of the line. As explained hereinabove, this advice may take the form of a sound signal and/or a tactile signal, for example a vibration.

Then, during a step 430, it is determined whether a message carried by the line can be interpreted. As explained hereinabove, interpretation may concern the width of the line, the alternation of parallel line elements or a bar code on or near the line, conductive or visible points or lines.

If the result of the step 430 is negative, the next step is the step 440.

If the result of the step 430 is positive, the user is provided with information representing the interpreted message, for example a voice message, during a step 435.

Then, during a step 440, the geographical position of the user is determined. During a step 445, the geolocation data memory is read to determine whether the geolocation data memory contains information linked to the position of the user, for example a street or building name, the presence of roadworks or activities open to the public. If so, during a step 450, the user hears a voice message representing this information.

This is followed by a return to the step 415. If the result of the step 445 is negative, the process returns directly to the step 415.

1. Fixed guidance device including, on a predefined path that may be taken by a visually impaired person, parallel to that path, a line (130, 211, 311) containing an electrically conductive material, characterized in that the quantity and/or the distribution of said conductive material is uniform on said line parallel to said path over a distance of at least one meter and is variable near events on said path.

2. Device according to claim 1, characterized in that said line (130, 211, 311) consists of a metal wire at least five centimeters below the surface of the ground.

3. Device according to claim 1, characterized in that said line (130, 211, 311) has, over distances of at least one meter, an increased width to indicate an impending first predetermined event on said path.

4. Device according to claim 1, characterized in that said line (130, 211, 311) has, over distances of at least one meter, at least two parallel electrically conductive elements to indicate an impending first predetermined event on said path.

5. Mobile guidance device for use conjointly with the fixed guidance device according to claim 1, characterized in that it includes:
a cane (201, 301),
an electrically conductive material detector (202, 302) positioned at the distal end of the cane, and
means (203 to 210, 303 to 305) for warning the user each time said detector detects an electrically conductive material.

6. Device according to claim 5, characterized in that it further includes means (204) for interpreting a quantity and/or distribution of electrically conductive material, the means (203 to 210) for warning the user being adapted to transmit a message representing the interpretation provided by the interpretation means.

7. Device according to claim 5, characterized in that it includes geolocation means (204) adapted to identify the geographical position of the device and to provide information linked to that position, the means (203 to 210) for warning the user being adapted to transmit a message representing the information provided by the geolocation means.

8. Device according to claim 5, characterized in that the sensitivity of the detector (202, 302) of the electrically conductive material (211, 311) is adapted not to detect the line except at a distance less than ten centimeters.

9. Device according to claim 5, characterized in that the means (203 to 210) for warning the user include:
a wireless signal transmitter (203) receiving the signals transmitted by the material detector, and
a receiver (204) of said signals transmitted by said transmitter associated with a sound signal emitter that emits a sound signal near at least one ear of the user.

10. Guidance method, including a step (400) of marking at least one path that may be taken by a visually impaired person to place thereon a line including an electrically conductive material, characterized in that, during the marking step, the quantity and/or the distribution of said conductive material is uniform parallel to said path over a distance of at least one meter and is variable near events on said path.

11. Device according to claim 2, characterized in that said line (130, 211, 311) has, over distances of at least one meter, an increased width to indicate an impending first predetermined event on said path.

12. Device according to claim 2, characterized in that said line (130, 211, 311) has, over distances of at least one meter, at least two parallel electrically conductive elements to indicate an impending first predetermined event on said path.

13. Mobile guidance device for use conjointly with the fixed guidance device according to claim 2, characterized in that it includes:
a cane (201, 301),
an electrically conductive material detector (202, 302) positioned at the distal end of the cane, and
means (203 to 210, 303 to 305) for warning the user each time said detector detects an electrically conductive material.

14. Device according to claim 6, characterized in that it includes geolocation means (204) adapted to identify the geographical position of the device and to provide information linked to that position, the means (203 to 210) for warning the user being adapted to transmit a message representing the information provided by the geolocation means.

15. Device according to claim 6, characterized in that the sensitivity of the detector (202, 302) of the electrically conductive material (211, 311) is adapted not to detect the line except at a distance less than ten centimeters.

16. Device according to claim 6, characterized in that the means (203 to 210) for warning the user include:
a wireless signal transmitter (203) receiving the signals transmitted by the material detector, and
a receiver (204) of said signals transmitted by said transmitter associated with a sound signal emitter that emits a sound signal near at least one ear of the user.
